(19) United States
(12) Patent Application Publication
(10) Pub. No.: US 2025/0015322 A1
(43) Pub. Date: Jan. 9, 2025

(54) FUEL CELL DETERIORATION DETERMINATION DEVICE AND FUEL CELL VEHICLE

(71) Applicant: SUBARU CORPORATION, Tokyo (JP)

(72) Inventor: Hideyuki TANEOKA, Tokyo (JP)

(21) Appl. No.: 18/708,371

(22) PCT Filed: Sep. 27, 2022
(86) PCT No.: PCT/JP2022/035874

§ 371 Date: May 8, 2024

(51) Int. Cl. H01M 8/04537; B60L 58/30; B60L 58/40; H01M 8/04664

(52) U.S. Cl. CPC H01M 8/04649; B60L 58/30; B60L 58/40; H01M 8/04679

(57) ABSTRACT

A fuel cell deterioration determination device includes an impedance measurer and a deterioration determiner. The impedance measurer applies an alternating current signal to a fuel cell stack and measure an alternating current impedance of the fuel cell stack. The deterioration determiner estimates, based on a characteristic of the measured alternating current impedance, a degree of an activation overvoltage in the fuel cell stack as deterioration of the catalyst metal, and also a degree of a diffusion overvoltage in the fuel cell stack as deterioration of the catalyst carrier. The deterioration determiner determines, based on reference values of the activation overvoltage and the diffusion overvoltage with respect to a vehicle travel distance held in advance, progresses of the deterioration of the catalyst metal and the deterioration of the catalyst carrier.

### TECHNICAL FIELD

The present disclosure relates to, for example, a fuel cell deterioration determination device and a fuel cell vehicle including the deterioration determination device.

### BACKGROUND ART

Transportation is indispensable in modern society, and various vehicles such as automobiles travel on roads on a daily basis. Among them, as a new driving source for supplying a driving force to a vehicle, a fuel cell having a relatively small load on the environment has been attracting attention.

In such a fuel cell, a fuel gas (hydrogen) is supplied to one electrode (fuel electrode) and an oxidant gas (oxygen) is supplied to the other electrode (air electrode), and these gases chemically react with each other to obtain electric energy. Therefore, in order to continuously obtain appropriate electric energy (generated electric power) from the fuel cell, it is expected to appropriately determine whether the fuel cell mounted on the vehicle has deteriorated.

An electrode catalyst (hereafter, also simply referred to as a “catalyst”) is one of components constituting the fuel cell. Such a catalyst has a form in which a catalyst metal such as platinum is bonded to a catalyst carrier such as carbon. For example, in the following PTL 1, an activation overvoltage is obtained based on the amount of electricity generated at the time of reduction of a catalyst in each cell constituting a fuel cell, and an FC voltage is estimated from the obtained activation overvoltage. At this time, PTL 1 proposes to compare the estimated FC voltage with an actual FC voltage detected by a voltage sensor, and to determine deterioration of the fuel cell based on the comparison result.

In addition, in PTL 2, attention is paid to a water content in a fuel cell as a reference for deterioration determination. It is proposed to estimate the water content by obtaining a proton transfer resistance and a gas reaction resistance using a Cole-Cole plot, which is a characteristic diagram illustrating a relationship between frequency and impedance on a complex plane.

### CITATION LIST

### Patent Literature

PTL 1: Japanese Unexamined Patent Application Publication No. 2009-043645
PTL 2: Japanese Unexamined Patent Application Publication No. 2020-87764

### SUMMARY OF INVENTION

### Technical Problem

Not only the above-mentioned patent literatures but also the current techniques do not satisfy the needs of the market, and the following problems exist.

That is, it has been found that dissolution of a catalyst metal having a small diameter occurs in an electrode of a fuel cell due to repetition of a voltage for repeating oxidation and reduction. At this time, a part of the dissolved metal may be re-deposited on metal particles having a large diameter. For example, the influence of an upper limit voltage value at the time of driving a vehicle greatly contributes to the occurrence of such an event.

On the other hand, it has been found that, for example, at the time of repetition of a voltage for normal acceleration/deceleration of the vehicle, corrosion of a catalyst carrier progresses even at a relatively low voltage if a scanning speed of the voltage is high.

As described above, when attention is paid to the catalyst with respect to the deterioration of the fuel cell, two kinds of deterioration, which are, deterioration of the catalyst metal and deterioration of the catalyst carrier, occur depending on a driving habit and daily traffic environment.

Both kinds of deterioration affect a decrease in performance of the fuel cell, and it can be a very important factor to appropriately determine which deterioration has progressed in order to continuously obtain appropriate electric energy from the fuel cell.

The present disclosure has been made in consideration of the above-described problems as an example, and an object of the present disclosure is to provide a fuel cell deterioration determination device and a fuel cell vehicle that can determine which of deterioration of a catalyst metal and deterioration of a catalyst carrier in a fuel cell has progressed.

### Solution to Problem

To solve the above problems, according to an aspect of the present disclosure, there is provided a fuel cell deterioration determination device. The fuel cell deterioration determination device is configured to determine deterioration of a catalyst including a catalyst metal and a catalyst carrier carrying the catalyst metal in a fuel cell stack. The fuel cell deterioration determination device includes an impedance measurer and a deterioration determiner. The impedance measurer is configured to apply an alternating current signal to the fuel cell stack and measure an alternating current impedance of the fuel cell stack. The deterioration determiner is configured to estimate, based on a characteristic of the measured alternating current impedance, a degree of an activation overvoltage in the fuel cell stack as deterioration of the catalyst metal, and also a degree of a diffusion overvoltage in the fuel cell stack as deterioration of the catalyst carrier. The deterioration determiner is configure to determine, based on reference values of the activation overvoltage and the diffusion overvoltage with respect to a vehicle travel distance held in advance, progresses of the deterioration of the catalyst metal and the deterioration of the catalyst carrier.

### Advantageous Effects of Invention

According to the present disclosure, it is possible to distinguish between the deterioration of the catalyst metal and the deterioration of the catalyst carrier. For example, when the corrosion of one of the catalyst metal and the catalyst carrier progresses at a speed higher than expected, it is possible to suppress the progress of the deterioration by correcting an operation parameter of the fuel cell.

### BRIEF DESCRIPTION OF DRAWINGS

FIG. 1 is a schematic diagram illustrating a configuration example of a fuel cell vehicle including a fuel cell deterioration determination device according to a first embodiment.

FIG. 2 is a schematic diagram illustrating each configuration and function of the fuel cell vehicle according to the first embodiment.

FIG. 3 is a schematic diagram illustrating a configuration example around a control device that also functions as the deterioration determination device according to the first embodiment.

FIG. 4 is a flowchart illustrating a method for determining deterioration of a catalyst in the fuel cell according to the first embodiment.

FIG. 5 is a schematic diagram illustrating an example of a Cole-Cole plot of a fuel cell stack according to the first embodiment.

FIG. 6 is a schematic diagram illustrating an example of a case where a high-frequency-side semicircle changes in the Cole-Cole plot illustrated in FIG. 5.

FIG. 7 is a schematic diagram illustrating an example of a case where a low-frequency-side semicircle changes in the Cole-Cole plot illustrated in FIG. 5.

FIG. 8 is an example of table data indicating a correspondence relationship between a travel distance, the high-frequency-side semicircle, and the low-frequency-side semicircle.

FIG. 9 is an example illustrating a time transition of a cell voltage during acceleration and deceleration in the fuel cell vehicle.

FIG. 10 is an example illustrating a time transition of the cell voltage in a case where a catalyst carrier deterioration suppression mode (No. 1) after deterioration determination is applied.

FIG. 11 is an example illustrating a time transition of the cell voltage in a case where the catalyst carrier deterioration suppression mode (No. 2) after deterioration determination is applied.

FIG. 12 is an example illustrating a time transition of the cell voltage in a case where a catalyst metal deterioration suppression mode after deterioration determination is applied.

FIG. 13 is a schematic diagram illustrating an example of a catalyst deterioration determination diagram of a fuel cell stack according to a second embodiment.

FIG. 14 is a schematic diagram illustrating an example of a case where a high-frequency-side plot has changed in the catalyst deterioration determination diagram illustrated in FIG. 13.

### DESCRIPTION OF EMBODIMENTS

Next, preferred embodiments of the present disclosure will be described. In the specification and the drawings, components having substantially the same function and configuration are denoted by the same reference numerals, and redundant description thereof will be omitted. In addition, for configurations other than those described in detail below, element techniques and configurations related to known fuel cell systems and fuel cell vehicles including the above-described patent literatures may appropriately serve as a complement.

### First Embodiment

### <Fuel Cell Vehicle FCV>

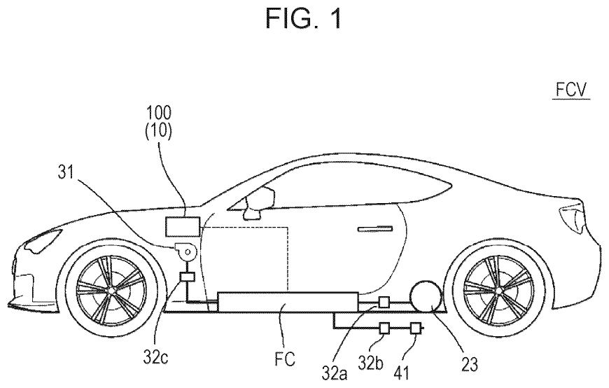

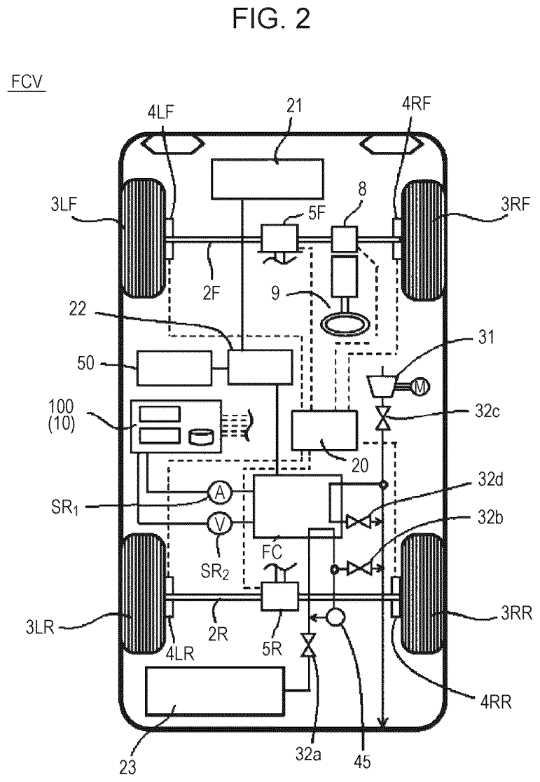

FIGS. 1 and 2 are schematic diagrams illustrating configuration examples and functional blocks of a fuel cell vehicle FCV including a fuel cell stack FC according to this embodiment. As illustrated in FIG. 2, the fuel cell vehicle FCV is configured as a four-wheel drive vehicle. In the four-wheel drive vehicle, a driving torque output from a driving force source 21, which generates a driving torque of the vehicle, is transmitted to a left front wheel 3LF, a right front wheel 3RF, a left rear wheel 3LR, and a right rear wheel 3RR (hereafter collectively referred to as “wheels 3” unless they are distinguished from one another). In this embodiment, the driving force source 21 can be exemplified by a known electric motor disposed on the front wheel side.

The electric motor serving as the driving force source 21 in this embodiment may be disposed on each of the front wheel side and the rear wheel side, or one electric motor may be disposed on each of the wheels 3. The driving force source 21 may further include an internal combustion engine such as a gasoline engine, a diesel engine, or a gas turbine engine, in addition to the electric motor.

A power supply system for supplying desired electric power to the driving force source 21 includes the fuel cell stack FC, hydrogen gas suppliers, air suppliers, a secondary battery 50, a known converter 22, and a control device 100 that controls these components. The fuel cell stack FC is formed by stacking known fuel cells such as PEFCs (polymer electrolyte fuel cells). The hydrogen gas suppliers each include a known hydrogen tank 23 and a pipe. The air suppliers each include a known compressor 31 and a pipe. The secondary battery 50 is a known secondary battery such as a lithium ion secondary battery or a lead storage battery. Note that the control device 100 in this embodiment also functions as a deterioration determination device 10 that determines deterioration of the fuel cell stack FC. In this power supply system, each of the fuel cell stack FC and the secondary battery 50 can supply electric power to a load including the electric motor.

As illustrated in FIG. 2, the fuel cell stack FC is connected to the load including the driving force source 21 (electric motor) via the converter 22 and wiring. In addition, as illustrated in FIG. 2, the current and the voltage in the fuel cell stack FC are detected by a known current sensor SR₁ and a known voltage sensor SR₂, respectively.

The converter 22 includes a known AC/DC converter that performs conversion between a direct current and an alternating current and a known DC/DC converter that adjusts the voltage of the direct current to a desired voltage. As an example, the converter 22 in this embodiment has a function of setting an output voltage generated and output by the fuel cell stack FC in response to a control signal of the control device 100. The converter 22 in this embodiment also has a function of increasing the voltage to a desired voltage when the electric power generated by the fuel cell stack FC is supplied to the load, and the like.

The fuel cell vehicle FCV in this embodiment includes the driving force source 21, an electric steering device 8, and brake devices 4LF, 4RF, 4LR, and 4RR as equipment used for operation control. Hereafter, the brake devices 4LF, 4RF, 4LR, and 4RR are collectively referred to as “brake devices 4” unless they are distinguished from one another.

The driving force source 21 outputs a driving torque that is transmitted to a front wheel drive axle 2F and a rear wheel drive axle 2R via a transmission (not illustrated), a front wheel differential mechanism 5F, and a rear wheel differential mechanism 5R. Driving of the driving force source 21 and the transmission is controlled by a known control device including one or more electronic control units (ECUs).

The front wheel drive axle 2F is provided with the electric steering device 8. The electric steering device 8 includes an electric motor and a gear mechanism (not illustrated), and adjusts steering angles of the left front wheel 3LF and the right front wheel 3RF by being controlled by a vehicle drive control device 20.

The vehicle drive control device 20 includes the driving force source 21, the electric steering device 8, and one or more known electronic control units (ECUs). The driving force source 21 outputs the driving torque of the fuel cell vehicle FCV. The electric steering device 8 controls a steering angle of a steering wheel 9 or a steered wheel. The one or more electronic control units (ECUs) control driving of the brake devices 4 that control a braking force of the fuel cell vehicle FCV. The vehicle drive control device 20 may have a function of controlling driving of the transmission that changes the speed of an output that is output from the driving force source 21 and transmits the output to the wheels 3.

As illustrated in FIG. 2, in the hydrogen gas supplier for supplying a fuel (hydrogen) gas to the fuel cell stack FC, the hydrogen gas stored in the hydrogen tank 23 is supplied to an anode-side flow path of the fuel cell stack FC via a hydrogen intake valve 32a or the like. The hydrogen intake valve 32a has a known structure installed in a hydrogen supply flow path.

A part of the hydrogen gas discharged from the fuel cell stack FC may be returned to the hydrogen supply flow path by a circulation flow path and a known circulation pump 45. In addition, the remaining part of the hydrogen gas discharged from the fuel cell stack FC is diluted by a diluting unit 41 at a predetermined timing through an opening/closing operation of a known hydrogen discharge valve 32b under the control of the control device 100. The diluted hydrogen gas is then released (discharged) to the atmosphere.

On the other hand, as illustrated in FIG. 2, the air supplier for supplying the oxygen gas (air) to the fuel cell stack FC includes, in addition to the compressor 31, a known oxygen intake valve 32c, an air discharge valve (back pressure valve) 32d, and the like. The oxygen intake valve 32c and the air discharge valve 32d adjust the amount of oxygen (air) supplied to a fuel cell 1. The air supplier may further include a known flow rate sensor (not illustrated) that can measure the flow rate of air supplied to the fuel cell stack FC.

The air taken in by the compressor 31 is supplied to a cathode-side flow path in the fuel cell stack FC via the oxygen intake valve 32c and a known humidifier (not illustrated). The air supplied to the fuel cell 1 is supplied as a cathode off-gas to the diluting unit 41 under the control of the oxygen discharge valve (back pressure valve) 32d by the control device 100.

The control device 100 includes one or more processors (CPUs (Central Processing Units)) and one or more memories communicably connected to the one or more processors. The control device 100 may be configured to be connectable to a known external network NET such as the Internet via various known communication devices CD such as a smartphone.

The compressor 31, valves 32, known sensors SR such as the current sensor SR₁ and the voltage sensor SR₂, and the like are electrically connected to the control device 100 directly or via communication network such as a CAN (controller area network) or a LIN (local inter net). The valves 32 are the hydrogen intake valve 32a, the hydrogen discharge valve 32b, the oxygen intake valve 32c, and the oxygen discharge valve 32d.

The fuel cell stack FC in this embodiment has a stack structure in which, for example, known fuel cells each having an electro-motive force of about 1 V are connected in series and stacked. As an example, the fuel cell stack FC in this embodiment can be exemplified by a polymer electrolyte fuel cell (PEFC). The polymer electrolyte fuel cell has a structure in which fuel cells are connected in series in a pair of known end plates for pressurizing and holding the fuel cell at both ends so as to obtain a system voltage expected by the fuel cell vehicle FCV.

Each of the fuel cells constituting the fuel cell stack FC has a structure in which a known MEA (membrane electrode assembly) is interposed between a pair of known separators disposed on a fuel electrode side and an air electrode side. The MEA includes at least a known cathode catalyst layer, a known anode catalyst layer disposed to face the cathode catalyst layer, and a known polymer electrolyte membrane disposed between the cathode catalyst layer and the anode catalyst layer. The membrane electrode assembly may further include an air electrode side gas diffusion layer and a fuel electrode side gas diffusion layer, each of which is known. The cathode catalyst layer in this embodiment has the following form. A known catalyst metal, for example, noble metal fine particles such as platinum (Pt) nanoparticles or platinum-cobalt (Pt—Co) particles, is bonded to a catalyst carrier exemplified by a metal material such as stainless steel or titanium, a carbon material, or the like.

### <Deterioration Determination Device 10>

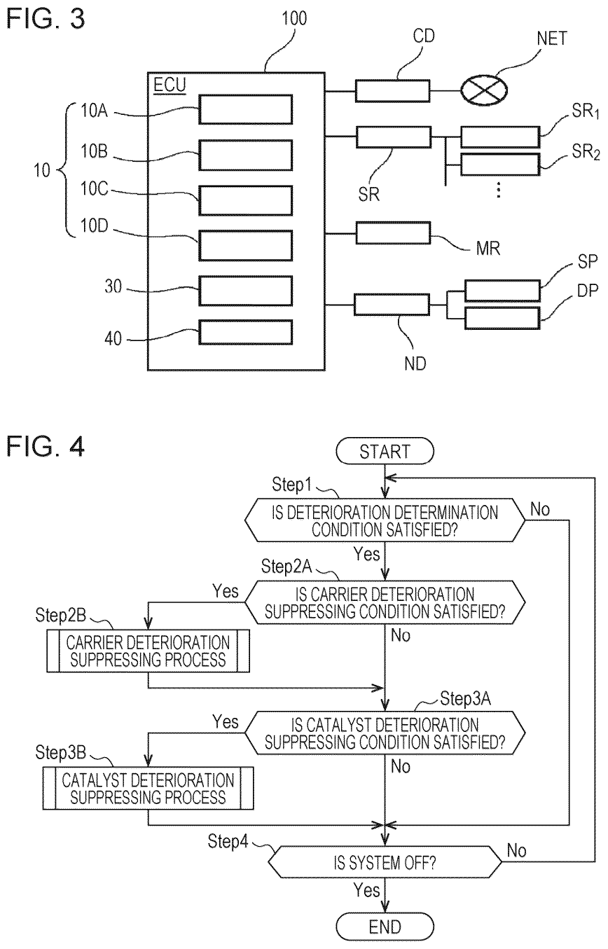

Next, with reference to FIG. 3, the deterioration determination device 10 capable of determining the deterioration of the catalyst in the fuel cell stack FC in this embodiment will be described. That is, the deterioration determination device 10 in this embodiment is configured to have a function of determining the deterioration of the catalyst including the catalyst metal and the catalyst carrier carrying the catalyst metal in the fuel cell stack FC.

The deterioration determination device 10 includes a current measurer 10A, a voltage measurer 10B, an impedance measurer 10C, and a deterioration determiner 10D. As described above, the deterioration determination device 10 is configured as one function executed by the control device 100 in this embodiment. As illustrated in FIG. 3, the control device 100 includes a drive controller 30 and a presentation controller 40.

The current measurer 10A is configured to have a function of measuring a current value of the fuel cell stack FC described above. For example, the current measurer 10A in this embodiment can measure the value of current flowing through the fuel cell stack FC via the current sensor SR₁ described above.

The voltage measurer 10B is configured to have a function of measuring a voltage value of the fuel cell stack FC described above. For example, the voltage measurer 10B in this embodiment can measure the value of voltage applied to the fuel cell stack FC via the voltage sensor SR₂ described above.

The impedance measurer 10C is configured to have a function of applying an alternating current signal for measurement to the fuel cell stack FC described above and measuring an alternating current impedance of the fuel cell stack FC. The impedance measurer 10C can measure the impedance of the fuel cell stack FC by a known alternating current impedance method, for example, based on the current value and the voltage value of the fuel cell described above.

The deterioration determiner 10D is configured to have a function of determining whether the catalyst in the fuel cell constituting the fuel cell stack FC has deteriorated based on characteristics of the measured alternating current impedance. For example, the deterioration determiner 10D in this embodiment can determine which of the catalyst metal and the catalyst carrier in the fuel cell has deteriorated by the following procedure.

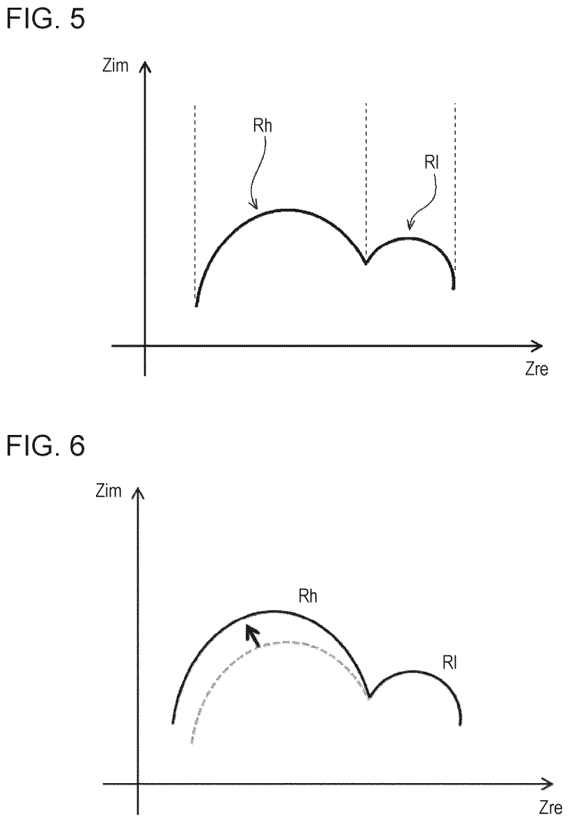

First, as illustrated in FIG. 5, the deterioration determiner 10D calculates a Nyquist diagram, based on the alternating current impedance measured as described above.

Subsequently, the deterioration determiner 10D defines an arc radius Rh on a high-frequency side in the calculated Nyquist diagram as a degree of the activation overvoltage, and defines an arc radius Rl on a low-frequency side in the Nyquist diagram as a degree of the diffusion overvoltage. In other words, the deterioration determiner 10D in this embodiment estimates the degree of the activation overvoltage in the fuel cell stack FC as the degree of the deterioration of the catalyst metal, and estimates the degree of the diffusion overvoltage in the fuel cell stack FC as the degree of the deterioration of the catalyst carrier.

In addition, in the fuel cell vehicle FCV in this embodiment, as illustrated in FIG. 8, reference values of the activation overvoltage and the diffusion overvoltage with respect to a vehicle travel distance are held in advance in a storage device MR. Such a reference value indicates a standard degree of the deterioration of the catalyst metal or the catalyst carrier in a case where the travel distance is integrated. The deterioration determiner 10D can read the reference values of the activation overvoltage and the diffusion overvoltage with respect to the vehicle travel distance by referring to the storage device MR. The above-described reference values of the activation overvoltage and the diffusion overvoltage with respect to the vehicle travel distance can be calculated in advance by an experiment or simulation using the vehicle.

Therefore, the deterioration determiner 10D determines the degrees of the deterioration (also referred to as the progresses of the deterioration) of the catalyst metal and the catalyst carrier. The determination is based on the arc radius on the high-frequency side (the degree of the activation overvoltage) and the arc radius on the low-frequency side (the degree of the diffusion overvoltage) in the calculated Nyquist diagram and the reference values of the activation overvoltage and the diffusion overvoltage with respect to the vehicle travel distance held in advance.

For example, as illustrated in FIG. 6, if the arc radius on the high-frequency side in the Nyquist diagram (the degree of the activation overvoltage) increases at a certain travel distance, the deterioration determiner 10D calculates the increased arc radius on the high-frequency side. Note that a known approximation method can be applied to the calculation of the arc radius described above. For example, the arc radius can be obtained by using a known approximation method such as the least squares method based on measurement points on the high-frequency side in the calculated Nyquist diagram.

Subsequently, the deterioration determiner 10D compares the calculated arc radius on the high-frequency side as described above with the reference value of the activation overvoltage (high-frequency semicircle radius) with respect to the vehicle travel distance illustrated in FIG. 8. The deterioration determiner 10D calculates the difference between the calculated arc radius on the high-frequency side and the reference value. For example, if the above-described deterioration determination is executed when the travel distance of the fuel cell vehicle FCV is 700 km, the arc radius on the high-frequency side is compared with a reference value a2.

Subsequently, for example, if the calculated arc radius on the high-frequency side exceeds the reference value a2, the deterioration determiner 10D can determine that the deterioration of the catalyst metal has progressed. In this embodiment, it is determined that the deterioration has progressed if the calculated arc radius on the high-frequency side exceeds the reference value. However, for example, it may be determined that the deterioration has progressed if the calculated arc radius exceeds an appropriate range of about several to 10% of the reference value.

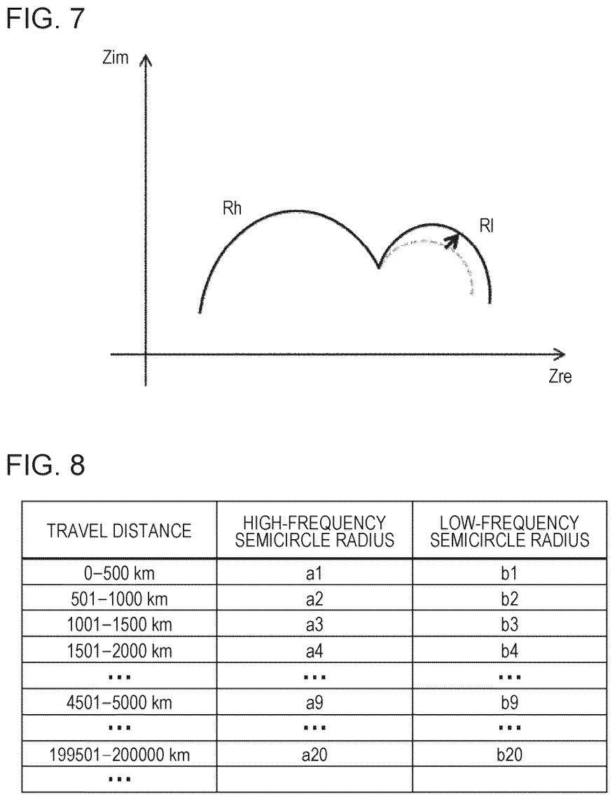

For example, as illustrated in FIG. 7, if the arc radius on the low-frequency side in the Nyquist diagram (the degree of the diffusion overvoltage) increases at a certain travel distance, the deterioration determiner 10D calculates the increased arc radius on the low-frequency side in the same manner as described above.

Subsequently, the deterioration determiner 10D compares the calculated arc radius on the low-frequency side with the reference value of the diffusion overvoltage (low-frequency semicircle radius) with respect to the vehicle travel distance illustrated in FIG. 8. The deterioration determiner 10D calculates the difference between the calculated arc radius on the low-frequency side and the reference value. For example, if the above-described deterioration determination is executed when the travel distance of the fuel cell vehicle FCV is 1700 km, the arc radius on the low-frequency side is compared with a reference value b4.

Subsequently, for example, if the calculated arc radius on the low-frequency side exceeds the reference value b4, the deterioration determiner 10D can determine that the deterioration of the catalyst carrier has progressed. In this embodiment, it is determined that the deterioration has progressed if the calculated arc radius on the low-frequency side exceeds the reference value. However, for example, it may be determined that the deterioration has progressed if the calculated arc radius exceeds an appropriate range of about several to 10% of the reference value.

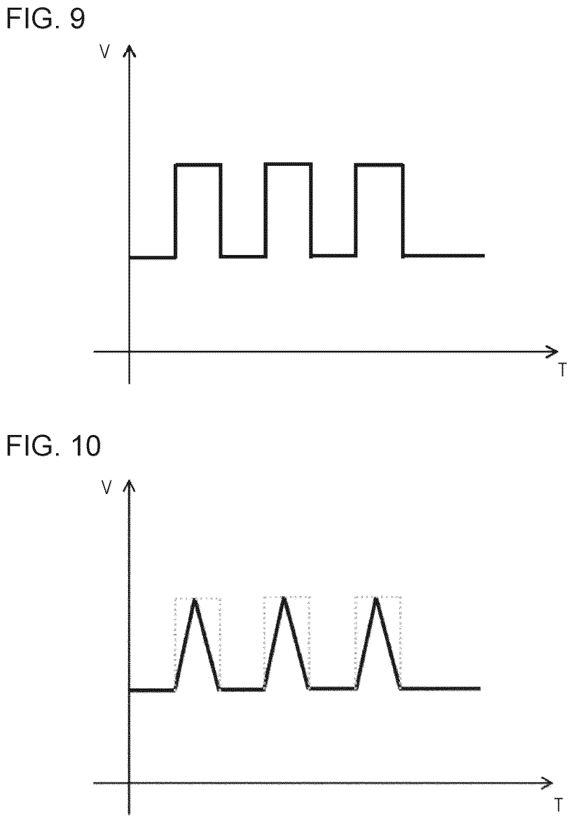

The drive controller 30 is configured to have a function of controlling the driving of the fuel cell stack FC. For example, the deterioration determiner 10D described above determines that the deterioration of the catalyst carrier has progressed (that is, the progress of the deterioration is fast on the diffusion overvoltage side). In this case, the drive controller 30 may decrease a rate of change in voltage per unit time in an acceleration/deceleration operation of the fuel cell vehicle FCV. For example, the drive controller 30 may perform control to decrease the rate of change in voltage per unit time in the acceleration/deceleration operation of the fuel cell vehicle FCV as illustrated in FIG. 10. This control is performed if the rate of change in voltage per unit time as illustrated in FIG. 9 is set as a standard state.

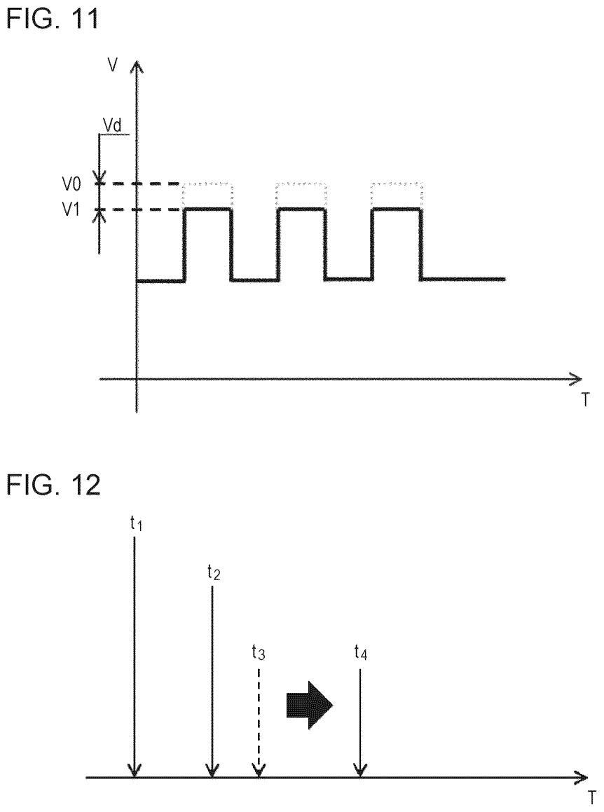

Furthermore, the deterioration determiner 10D described above determines that the deterioration of the catalyst carrier has progressed. In this case, the drive controller 30 may perform control to delay the timing of introducing air to a cathode electrode at a start-up of the fuel cell stack FC as compared with a normal time, as illustrated in FIG. 11. For example, in a state in which the progress of the deterioration is in the standard state, as illustrated in FIG. 11, the system of the fuel cell vehicle FCV is turned on and a start-up request of the fuel cell stack FC is generated at a time t1. In response to this, normally, after the supply of the hydrogen gas to the anode-side flow path via the hydrogen intake valve 32a is started at a time t2, the supply of air to the cathode-side flow path via the oxygen intake valve 32c and the like is started at a time t3. In contrast, if it is determined that the deterioration of the catalyst carrier has progressed, the drive controller 30 can execute control to delay the supply of air to the cathode-side flow path until a time t4 later than the time t3.

Note that the degree of the delay from the time t3 to the time t4 may be set, for example, in accordance with the degree of the deterioration of the catalyst carrier. That is, the drive controller 30 can set the time t4 by increasing the degree of the delay as the degree of the deterioration of the catalyst carrier increases.

On the other hand, the deterioration determiner 10D described above determines that the deterioration of the catalyst metal has progressed (that is, the progress of the deterioration is fast on the activation overvoltage side). In this case, the drive controller 30 can execute control to suppress the upper limit voltage value of the fuel cell stack FC used in the fuel cell vehicle FCV as illustrated in FIG. 12. For example, if the upper limit voltage value of the fuel cell stack FC is set to V0 in a state in which the progress of the deterioration is in the standard state, the drive controller 30 can set the upper limit voltage value to V1 by decreasing the upper limit voltage value from V0 by Vd. Note that a voltage drop degree Vd described above may be appropriately set in accordance with the vehicle type, specifications of an electric motor, and the like.

At this time, the drive controller 30 may suppress the upper limit voltage value of the fuel cell stack FC used in the fuel cell vehicle FCV in accordance with the deterioration on an activation voltage side. For example, if the arc radius on the high-frequency side is compared with the reference value corresponding to the travel distance at that time, the upper limit voltage value described above may be suppressed to a greater extent as the degree of excess from the reference value increases.

The presentation controller 40 executes a process of presenting various kinds of information such as a deterioration state of the fuel cell stack FC via a presentation device DD including a known in-vehicle speaker SP and a display DP. The presentation controller 40 may present various kinds of information described above to an occupant via the presentation device DD mounted on the vehicle, or may perform control to access an external terminal such as a smartphone possessed by the occupant and present the information.

### <Deterioration Suppressing Method of Catalyst Metal and Catalyst Carrier>

Next, referring also to FIG. 4, a deterioration suppressing method of the catalyst metal and the catalyst carrier, which can be executed by the control device 100 including the deterioration determination device 10 in this embodiment, will be described. Note that the deterioration suppressing method may be used as an algorithm of a computer-readable program. For example, the program having such an algorithm may be distributed in a downloadable manner to the fuel cell vehicle FCV via a known network, or may be distributed by being stored in a recording medium.

Hereinafter, for example, a case where a user starts the system of the fuel cell vehicle FCV to start traveling will be described as an example.

First, in Step 1, the control device 100 determines whether a deterioration determination condition of the fuel cell stack FC is satisfied. For example, the control device 100 may determine whether the fuel cell stack FC has reached an appropriate temperature, based on a known temperature sensor (not illustrated) in order to determine whether the fuel cell stack FC has entered a state in which it can be stably driven. The control device 100 may further determine whether a water content state of the fuel cell stack FC has become appropriate, based on a known water content measurement method exemplified in PTL 2, for example.

If the deterioration determination condition is satisfied in Step 1, the control device 100 determines whether a carrier deterioration suppressing condition is satisfied in subsequent Step 2. For example, in Step 2A, the deterioration determiner 10D described above calculates the Nyquist diagram, based on the measured alternating current impedance. Subsequently, the deterioration determiner 10D determines the progress of the deterioration of the catalyst carrier by obtaining the difference between the arc radius on the low-frequency side (the degree of diffusion overvoltage) and the reference value using the calculated Nyquist diagram and the reference value held in the storage device MR.

If it is determined in Step 2A that the deterioration of the catalyst carrier has progressed beyond the reference value (Yes in Step 2A), the process proceeds to Step 2B, and a carrier deterioration suppressing process is executed. That is, in step 2B, the control device 100 (the drive controller 30) can execute one or more of (α) and (β). (α) is control to decrease the rate of change in voltage per unit time in the acceleration/deceleration operation of the fuel cell vehicle FCV, as illustrated in FIG. 10. (β) is control to delay the timing of introducing air to the cathode electrode at the start-up of the fuel cell stack FC as compared with the normal time, as illustrated in FIG. 11.

On the other hand, if it is determined in Step 2A that the deterioration of the catalyst carrier is within a range of the reference value (the deterioration has not progressed more than expected) (No in Step 2A), the process proceeds to Step 3A, and it is determined whether a catalyst deterioration suppressing condition is satisfied. That is, in Step 3A, the deterioration determiner 10D described above calculates the Nyquist diagram, based on the measured alternating current impedance. Subsequently, using the calculated Nyquist diagram and the reference value held in the storage device MR, the deterioration determiner 10D determines the difference between the arc radius on the high-frequency side (the degree of the activation overvoltage) and the reference value to determine the progress of the deterioration of the catalyst metal.

If it is determined in Step 3A that the deterioration of the catalyst metal has progressed beyond the reference value (Yes in Step 3A), the process proceeds to Step 3B, and a catalyst metal deterioration suppressing process is executed. That is, in Step 3B, the control device 100 (the drive controller 30) can execute control to suppress the upper limit voltage value of the fuel cell stack FC used in the fuel cell vehicle FCV, as illustrated in FIG. 12.

Subsequently, in Step 4, the control device 100 determines whether the system of the fuel cell vehicle FCV is turned off. If the system is not turned off yet (No in Step 4), the control device 100 returns to Step 1 and repeats the above-described process. On the other hand, if the system of the fuel cell vehicle FCV is turned off in Step 4 (Yes in Step 4), the above-described deterioration suppressing method of the catalyst metal and the catalyst carrier is ended.

According to the deterioration suppressing method of the catalyst metal and the catalyst carrier described above, it is possible to distinguish between the deterioration of the catalyst metal and the deterioration of the catalyst carrier. The distinction is made by using the arc radius on the high-frequency side (the degree of the activation overvoltage) and the arc radius on the low-frequency side (the degree of the diffusion overvoltage) derived from the Nyquist diagram. Furthermore, according to the control device 100 in this embodiment, for example, in a case where the corrosion progresses at a speed equal to or higher than an assumed speed by any one of these, it is possible to suppress the progress of the deterioration in the catalyst by correcting an operation parameter of the fuel cell described above.

### <Computer Program and Recording Medium>

Note that a computer program that implements each function of the deterioration determination device 10 described above is applied to a fuel cell deterioration determination device. The fuel cell deterioration determination device determines deterioration of a catalyst including a catalyst metal and a catalyst carrier carrying the catalyst metal in a fuel cell stack. The computer program can cause one or more processors to apply an alternating current signal to the fuel cell stack and measure an alternating current impedance of the fuel cell stack. The computer program can cause the one or more processors to estimate, based on a characteristic of the measured alternating current impedance, a degree of an activation overvoltage in the fuel cell stack as deterioration of the catalyst metal, and also a degree of a diffusion overvoltage in the fuel cell stack as deterioration of the catalyst carrier. The computer program can cause the one or more processors to determine, based on reference values of the activation overvoltage and the diffusion overvoltage with respect to a vehicle travel distance held in advance, progresses of the deterioration of the catalyst metal and the deterioration of the catalyst carrier.

Furthermore, in addition to the above-described algorithm, the computer program that implements each function of the control device 100 including the deterioration determination device 10 can suppress an upper limit voltage value of a fuel cell vehicle. The upper limit voltage value of the fuel cell vehicle is suppressed in accordance with the deterioration on a side of an activation voltage in a case where it is determined that the progress of the deterioration is fast on a side of the activation overvoltage. In addition to the above-described algorithm, the computer program that implements each function of the control device 100 including the deterioration determination device 10 can execute one or more of (α) and (β). (α) is to decrease a rate of change in voltage per unit time in an acceleration/deceleration operation of the fuel cell vehicle. (β) is to delay a timing of introducing air to a cathode electrode at a start-up of the fuel cell as compared with a normal time.

In addition, such a computer program may be stored in, for example, a known recording medium described above, or may be downloaded to the fuel cell vehicle FCV from a known server such as a cloud.

### Second Embodiment

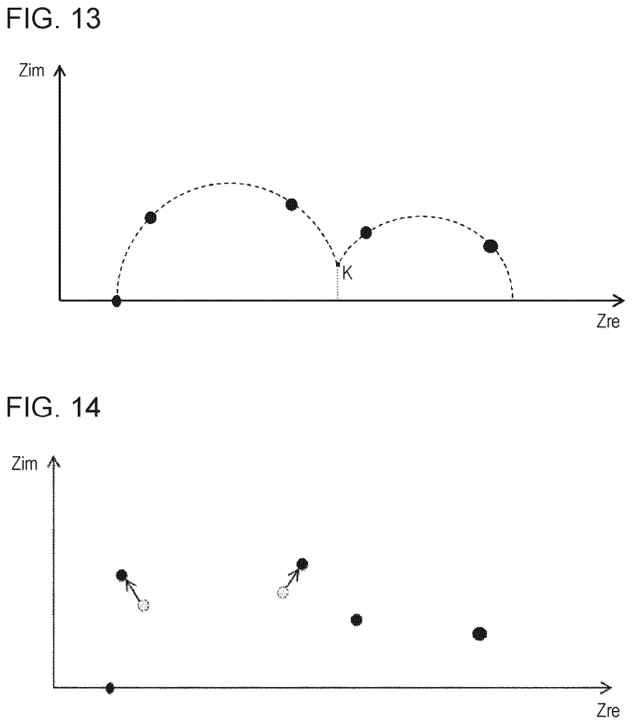

A fuel cell deterioration determination device according to a second embodiment will be described below with reference to FIGS. 13 and 14. In the first embodiment described above, the Nyquist diagram is generated from the measured alternating current impedance to determine the progress of the deterioration of each of the catalyst metal and the catalyst carrier. In contrast, the deterioration determination device according to the second embodiment is characterized mainly in that it is not necessary to generate the Nyquist diagram, and the progress of the deterioration of each of the catalyst metal and the catalyst carrier is determined based on measurement points obtained from the alternating current impedance.

Therefore, in the following description of the second embodiment, the above-described features will be mainly described, and components having the same functions as those in the above-described first embodiment are denoted by the same reference numerals, and the description of such components will be omitted as appropriate.

That is, in this embodiment, after the deterioration determination condition is satisfied in Step 1, the control device 100 extracts the measurement points, based on the measured alternating current impedance in Step 2A.

For example, as illustrated in FIG. 13, the deterioration determiner 10D extracts the measurement points in each of a high-frequency-side region and a low-frequency-side region, based on the measured alternating current impedance. The boundary between the high-frequency-side region and the low-frequency-side region can be set to, for example, a central inflection point K (an inflection point sandwiched between an inflection point in the high-frequency-side region and an inflection point in the low-frequency-side region, see FIG. 13) when the Nyquist diagram is generated.

Note that, in FIG. 13, in this embodiment, three measurement points and two measurement points are extracted in the high-frequency-side region and the low-frequency-side region, respectively. However, the present disclosure is not limited to this form, and any measurement points may be extracted in the high-frequency-side region and the low-frequency-side region within a range that does not lead to generation of the Nyquist diagram.

As illustrated in FIG. 13, a diagram in which the measurement points are extracted to such an extent that the Nyquist diagram is not generated, based on the measured alternating current impedance, is referred to as a “catalyst deterioration determination diagram” in this embodiment.

Subsequently, in Step 2A, the control device 100 determines the progresses of the deterioration of the catalyst metal and the deterioration of the catalyst carrier, based on the reference values of the activation overvoltage and the diffusion overvoltage, respectively, with respect to the vehicle travel distance, which are held in advance, in Step 2A and Step 3A, in the same manner as in the first embodiment.

For example, as illustrated in FIG. 14, if a high-frequency-side plot (measurement points) has changed in the catalyst deterioration determination diagram, the control device 100 calculates the arc radius by applying the above-described known approximation method with reference to the position of the increased high-frequency-side plot. Thereafter, as in the first embodiment, the control device 100 compares the calculated arc radius on the high-frequency side with the reference value of the activation overvoltage (high-frequency semicircle radius) with respect to the vehicle travel distance. The control device 100 calculates the difference between the calculated arc radius on the high-frequency side and the reference value.

Although FIG. 14 illustrates the case where the high-frequency-side plot (measurement points) has changed in the catalyst deterioration determination diagram, the degree of the deterioration of the catalyst carrier can be obtained in the same manner also in a case where a low-frequency-side plot has changed. That is, the control device 100 may compare the calculated arc radius on the low-frequency side with the reference value of the diffusion overvoltage (low-frequency semicircle radius) with respect to the vehicle travel distance, and calculate the difference between the calculated arc radius on the low-frequency side and the reference value.

In this manner, in the catalyst deterioration determination diagram in the second embodiment, the displacement of the measurement points belonging to the high-frequency-side region of the central inflection point K as a boundary is used to estimate the degree of the deterioration of the catalyst metal. Also, the displacement of the measurement points belonging to the low-frequency-side region of the central inflection point K is used to estimate the degree of the deterioration of the catalyst carrier.

As a result, according to the control device 100 including the deterioration determination device 10 and the fuel cell vehicle FCV according to the second embodiment, although the approximation accuracy of the arc radius is slightly reduced, it is possible to distinguish between the deterioration of the catalyst metal and the deterioration of the catalyst carrier in the same manner as in the first embodiment. Also, a calculation load of the control device is reduced.

The preferred embodiments of the present disclosure have been described above in detail with reference to the accompanying drawings, but the technology of the present disclosure is not limited to such examples. It is clear that a person having ordinary skill in the art can conceive of various modifications or corrections within the technical idea described in the claims. It is to be understood that these are naturally included in the technical scope of the disclosure.

### REFERENCE SIGNS LIST

10 deterioration determination device
20 vehicle drive control device
30 drive controller
40 presentation controller
FC fuel cell stack
FCV fuel cell vehicle

1. A fuel cell deterioration determination device configured to determine deterioration of a catalyst including a catalyst metal and a catalyst carrier carrying the catalyst metal in a fuel cell stack, the fuel cell deterioration determination device comprising:
an impedance measurer configured to apply an alternating current signal to the fuel cell stack and measure an alternating current impedance of the fuel cell stack; and
a deterioration determiner configured to estimate, based on a characteristic of the measured alternating current impedance, a degree of an activation overvoltage in the fuel cell stack as deterioration of the catalyst metal, and also a degree of a diffusion overvoltage in the fuel cell stack as deterioration of the catalyst carrier, and determine, based on reference values of the activation overvoltage and the diffusion overvoltage with respect to a vehicle travel distance held in advance, progresses of the deterioration of the catalyst metal and the deterioration of the catalyst carrier.

2. The fuel cell deterioration determination device according to claim 1, wherein
the deterioration determiner is configured to:
calculate, based on the alternating current impedance, a Nyquist diagram; and
by setting an arc radius on a high-frequency side in the calculated Nyquist diagram as the degree of the activation overvoltage, and an arc radius on a low-frequency side in the Nyquist diagram as the degree of the diffusion overvoltage, determine the progresses of the deterioration of the catalyst metal and the deterioration of the catalyst carrier.

3. A fuel cell vehicle comprising:
the deterioration determination device according to claim 1;
a fuel cell electrically connected to the deterioration determination device; and
a control device configured to control driving of the fuel cell, wherein
the control device is configured to
in a case where it is determined that the progresses of the deterioration of the catalyst metal and the deterioration of the catalyst carrier are fast on a side of the activation overvoltage, suppress an upper limit voltage value of the fuel cell vehicle in accordance with the deterioration on a side of the activation overvoltage.

4. The fuel cell vehicle according to claim 3, wherein
the control device is configured to
in a case where it is determined that the progresses of the deterioration of the catalyst metal and the deterioration of the catalyst carrier are fast on a side of the diffusion overvoltage,
execute one or more of (α) decreasing a rate of change in voltage per unit time in an acceleration/deceleration operation of the fuel cell vehicle and (β) delaying a timing of introducing air to a cathode electrode at a start-up of the fuel cell as compared with a normal time.

5. A fuel cell vehicle comprising:
the deterioration determination device according to claim 2;
a fuel cell electrically connected to the deterioration determination device; and
a control device configured to control driving of the fuel cell, wherein
the control device is configured to
in a case where it is determined that the progresses of the deterioration of the catalyst metal and the deterioration of the catalyst carrier are fast on a side of the activation overvoltage, suppress an upper limit voltage value of the fuel cell vehicle in accordance with the deterioration on a side of the activation overvoltage.

6. The fuel cell vehicle according to claim 5, wherein
the control device is configured to
in a case where it is determined that the progresses of the deterioration of the catalyst metal and the deterioration of the catalyst carrier are fast on a side of the diffusion overvoltage,
execute one or more of (α) decreasing a rate of change in voltage per unit time in an acceleration/deceleration operation of the fuel cell vehicle and (β) delaying a timing of introducing air to a cathode electrode at a start-up of the fuel cell as compared with a normal time.

7. A fuel cell deterioration determination device configured to determine deterioration of a catalyst including a catalyst metal and a catalyst carrier carrying the catalyst metal in a fuel cell stack, the fuel cell deterioration determination device comprising circuitry configured to:
apply an alternating current signal to the fuel cell stack and measure an alternating current impedance of the fuel cell stack; and
estimate, based on a characteristic of the measured alternating current impedance, a degree of an activation overvoltage in the fuel cell stack as deterioration of the catalyst metal, and also a degree of a diffusion overvoltage in the fuel cell stack as deterioration of the catalyst carrier, and determine, based on reference values of the activation overvoltage and the diffusion overvoltage with respect to a vehicle travel distance held in advance, progresses of the deterioration of the catalyst metal and the deterioration of the catalyst carrier.
